(19) United States
(12) Patent Application Publication
(10) Pub. No.: US 2021/0328543 A1
(43) Pub. Date: Oct. 21, 2021

(54) PHOTOVOLTAIC ARRAY AND AGRICULTURAL DUAL METHOD OF USE: AGRIVOLTAICS

(71) Applicant: Solar Provider Group Ltd., Royal Westmoreland (BB)

(72) Inventors: Christian Wentzel, Royal Westmoreland (BB); Wojciech Marek Kozlowski, Toronto (CA); Vivian Lam, Toronto (CA)

(21) Appl. No.: 17/362,987

(22) Filed: Jun. 30, 2021

Related U.S. Application Data
(60) Provisional application No. 63/112,741, filed on Nov. 12, 2020.

(51) Int. Cl. H02S 20/32; H02S 20/10; A01G 9/24

(52) U.S. Cl. CPC H02S 20/32; A01G 9/243; H02S 20/10

(57) ABSTRACT

A method of simultaneous use of agricultural land for food production, biodiversity creation, and renewable power generation through the mounting of photovoltaic panel arrays at a distance of 7 meters (22.9659 feet) to 11 meters (36.0892 feet) from one array row to the following array row, to allow for adequate passage of mechanized farm equipment to pass between array rows, in addition to accommodating various livestock grazing activities, orchard planting, and beekeeping activities. The method of operation is optimized for energy generation, while keeping with the local landscape and native agricultural activities on the land to improve agricultural efficiency of the land.

### CROSS-REFERENCE TO RELATED PATENT DOCUMENTS

This patent application claims the benefit of priority of U.S. Provisional Application No. 63/112,741, entitled “PHOTOVOLTAIC ARRAY AND AGRICULTURAL DUAL METHOD OF USE: AGRIVOLTAICS,” filed 12 Nov. 2020, which are hereby incorporated herein by reference in its entirety.

### FIELD OF INVENTION

Various embodiments of the disclosure relate generally to “agrivoltaics”, “Agrivoltaik”, “Agrivoltaiks”, “agriphotovoltaics.” “Agrivoltaics”, or “Agriphotovoltaics” and may correspond to a mechanism of using photovoltaic panel arrays for generating electrical power and optimizing growth of agricultural crop and enhancing biodiversity on the same property. More specifically, various embodiments of the disclosure relate to the photovoltaic panel arrays that are spaced from a first distance (for example, 7 meters i.e., 22.9659 feet) to a second distance (for example, 11 meters i.e., 36.0892 feet) apart. Such arrangement of the photovoltaic panel arrays may allow for a wider variety of agricultural use ranging from beekeeping, sheep grazing, monocropping, intercropping, polyculture, and the like, as it allows for adequate spacing for the average farming machine to pass between array rows.

### BACKGROUND

Solar energy harnessed by photovoltaic panels has been gaining popularity due to legislative changes that promote the use of renewable energy to fight climate change paired with rebates and incentives from state governments contributing to improved economics. With societal progress and technological advancements, the recent trends indicate that the cost of solar panels has been falling and interest in renewable energy has been growing. Large solar array systems are fulfilling this demand for solar energy, and their popularity has grown due to the inherent cost economies of scale. Large land parcels located on flat, cleared terrain, set back from often environmentally sensitive areas and close to electrical infrastructure are ideal sites for large solar arrays. This frequently limits available sites to mainly agricultural land. With limited arable land, diverting it to solely produce electricity has been a point of contention, especially for rural communities that rely on agricultural activities for their livelihood.

In order to solve the above problems, the US Patent Publication Number 20200083838 discloses a method for double cropping, with photovoltaic panel arrays mounted on and operating from specialized photovoltaic solar array support structures that are built above agricultural fields. They are constructed at heights that allow the passage of average and large mechanized sized farm equipment to pass beneath. The patent application discloses mounting and operation of the photovoltaic panel arrays above agricultural fields at heights that allow mechanized farm equipment to pass underneath. However, this limits machinery height, creates significantly more risk of support structure collapse in case of malfunction or natural occurrences, requires higher costs for materials and maintenance, in addition to a more visible solar array which is a deterrent for communities where the array is located. Adequate screening prevents glare and obstructs the view of the photovoltaic system from view by the community. Screening is situationally dependent, with factors such as municipality regulations, fencing height, system design and topography, to name a few. Increase in screening height increases costs, adds safety concerns due to higher chance of collapse, in addition to creating a variance and significant visual impact in the local landscape. Thus, in light of the foregoing, there exists a need for a technical and reliable solution that overcomes the above-mentioned problems, challenges, and short-comings, and provides a new and enhanced mechanism that allows agricultural activities to continue or alternate while producing renewable electricity through large photovoltaic arrays that would optimize the utility of the land. This specific mechanism would not require any additional costs or structures, is non-intrusive, and allows agricultural flexibility.

### SUMMARY

It is an object of the present disclosure to provide a mechanism of using photovoltaic panel arrays for generating electrical power and optimizing growth of agricultural crop on the same property. The photovoltaic panel arrays are spaced in an arrangement such that the photovoltaic panel arrays may allow for a wider variety of agricultural use ranging from beekeeping, sheep grazing, monocropping, intercropping, polyculture, and the like. Further, such arrangement may allow for adequate spacing for the average farming machine to pass between array rows.

It is an object of the present disclosure to provide the photovoltaic panel arrays that are spaced (or gapped) from a first distance (for example, 7 meters i.e., 22.9659 feet) to a second distance (for example, 11 meters i.e., 36.0892 feet) apart and hence such spacing may allow for agricultural activities to occur between the panel rows, while generating solar energy with the panels.

In an exemplary embodiment, the spacing of 7 meters (i.e., 22.9659 feet) to 11 meters (i.e., 36.0892 feet) between array rows may allow one or more mechanized farm equipment to pass between the array rows, and thereby providing proper spacing for planting and harvesting of crops. Spacing at this distance range may also allow for adequate sunshine to reach the crops and soil, regardless of panel orientation or panel type. This may include, but is not limited to, fixed tilt systems and single axis tracking systems. In another exemplary embodiment, the space between the panels may be used for sheep and livestock grazing. Grazing animals help maintain the cover crop, reducing maintenance costs by up to 30% according to the American Solar Grazing Association (ASGA). In another exemplary embodiment, the space between the panels may be used for beekeeping and pollinator conservation. According to beekeeping experts, the space between the hives should maintain 7 feet (i.e., 2.1336 meter) radius to ensure hive health. Pollinator-friendly native crops may also be planted in place of typical gravel roads between the array rows of the traditional large-scale photovoltaic array.

The disclosed photovoltaic system, designed to work in conjunction with agricultural activities using the spaced array rows 7 meters to 11 meters apart, may be adaptable to different types of farming. It is also suitable with different project configurations, array arrangements, and system designs, and may be used with different module types. The system does not disturb ongoing farming activities in the areas between panel rows.

In an exemplary embodiment, the photovoltaic panels may be configured in a static array. The use of such configuration of the panels has sufficient spacing whereby the sunlight needed to facilitate crop growth between rows is available. Shade coverage due to sun orientation, which is time, latitude, and seasonally dependent, may provide partial shade to reduce evaporation of water in the growing cycle allowing for water retention and reduced irrigation costs and resource depletion.

In another exemplary embodiment, a photovoltaic panel array using tracking device (installed in the array) including tracking software. The tracking device controls the movement of the arrays and follow sun position for better efficiency. This does not impede the crop growth or other farming activities between rows due to adequate spacing of 7 meters minimum and maximum of 11 meters. The tracking of the solar panels to the position of the sun may help in optimizing power or energy generation in addition to providing adequate sunshine and shade to enhance growing conditions. The shading may reduce evaporation of water provided through irrigation systems, thereby reducing the cost of irrigation. Additionally, a photovoltaic system designed with single axis tracking may allow for side-to-side rotation of 60-degree angles, allowing for additional horizontal and vertical space between the array rows for additional farming practices.

In another exemplary embodiment, a photovoltaic panel system with spacing between rows of 7 meters to 11 meters allowing for continual agricultural use may increase biodiversity. In another exemplary embodiment, the photovoltaic panel system with spacing between rows of 7 meters to 11 meters allows for dwarf apple tree growth. Typical solar systems avoid tree planting to eliminate shading on panels. With an average dwarf apple tree at 5 feet (i.e., 1.524 meters) to 6 feet (i.e., 1.8288 meters) in height, spacing of 8 meters (26.2467 feet) to 11 meters (36.0892 feet) may allow for shade avoidance of panels while panel shading of tree and roots is minimal to none. In another exemplary embodiment, the photovoltaic panel system with spacing between rows of 7 meters to 11 meters may allow for more solar power adoption from communities. Incorporating agriculture and dual usage of the land may stimulate the local economy through continual production of crops.

Various modifications may be made to the embodiments and design discussed without departing from the scope of the present invention. For example, the scope of this invention includes different combinations of features such as crop selection, livestock selection, orchard selection, or pollinator conservation. The scope of this invention also includes embodiments having different combinations of features that do not include all the above-described features.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

The invention is explained in further detail, and by way of example, with reference to the accompanying drawings wherein:

FIG. 1 is a diagram that illustrates a side view of a photovoltaic panel array in a south facing position in its fixed position, in accordance with an exemplary embodiment of the disclosure.

FIG. 2 is diagram that illustrates a side view of a photovoltaic panel array in a fixed east-west facing orientation, in accordance with an exemplary embodiment of the disclosure.

FIG. 3 is a diagram that illustrates a side view of a single axis tracker photovoltaic panel array in its typical raised position along with panel rotation in 60-degree intervals according to sun position, in accordance with an exemplary embodiment of the disclosure.

FIG. 4 is a diagram that illustrates a side view of fix tilt south facing photovoltaic panel arrays spaced apart, in accordance with an exemplary embodiment of the disclosure.

FIG. 5 is a diagram that illustrates a side view of a dwarf apple tree orchard between the photovoltaic panel arrays in a south-facing orientation, in accordance with an exemplary embodiment of the disclosure.

FIG. 6 is a diagram that illustrates a side view of the photovoltaic panel arrays in a south-facing orientation with crops between the arrays, in accordance with an exemplary embodiment of the disclosure.

FIG. 7 is a diagram that illustrates a side view of the photovoltaic panel arrays in an east-west orientation with a row of dwarf orchard trees between the arrays, in accordance with an exemplary embodiment of the disclosure.

FIG. 8 is a diagram that illustrates a side view of the photovoltaic panel arrays in an east-west orientation that allows a mechanized piece of farming equipment to pass between the arrays, in accordance with an exemplary embodiment of the disclosure.

FIG. 9 is a diagram that illustrates a side view of the photovoltaic panel arrays in an east-west orientation that allows for crop rows to grow between the arrays, in accordance with an exemplary embodiment of the disclosure.

FIG. 10 is a diagram that illustrates a side view of the photovoltaic panel arrays in an east-west orientation that allows for standard beekeeping hives between the arrays, in accordance with an exemplary embodiment of the disclosure.

FIG. 11 is a diagram that illustrates a side view of single axis tracker photovoltaic panel arrays in its typical raised position along with panel rotation according to sun position that allows for standard farming equipment to pass between arrays, in accordance with an exemplary embodiment of the disclosure.

FIG. 12 is a diagram that illustrates a side view of single axis tracker photovoltaic panel arrays in its typical raised position along with panel rotation according to sun position that allows for crop growth between arrays, in accordance with an exemplary embodiment of the disclosure.

FIG. 13 is a diagram that illustrates a side view of single axis tracker photovoltaic panel arrays in its typical raised position along with panel rotation according to sun position that allows for two standard bee keeping hives between the arrays, in accordance with an exemplary embodiment of the disclosure.

FIG. 14 is a diagram that illustrates a side view of the photovoltaic panel arrays in a south-facing orientation that allows for standard beekeeping hives between the arrays, in accordance with an exemplary embodiment of the disclosure.

FIG. 15 is a diagram that illustrates a side view of two rows of single axis tracking photovoltaic panel arrays with a combination of crops, dwarf trees, and beehives, in accordance with an exemplary embodiment of the disclosure.

FIG. 16 is a diagram that illustrates a top-down view of the sun's position during different times of the day relative to the photovoltaic panel array, in accordance with an exemplary embodiment of the disclosure.

FIG. 17 is a diagram that illustrates a side view of two rows of south-facing fixed tilt panel arrays with a row of crops between the arrays, in accordance with an exemplary embodiment of the disclosure.

The figures depict various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in an embodiment” or “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. In addition, as used herein, the term “or” is an inclusive “or” operator and is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” may include singular or plural references. The meaning of “in” includes “in” and “on.”

The following is a description of illustrative embodiments that when taken in conjunction with the following drawings will demonstrate the above noted features and advantages, as well as further ones. In the description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well-known devices, tools, techniques, and methods are omitted so as not to obscure the description of the present system. It should be expressly understood that the drawings are included for illustrative purposes and do not represent the scope of the present system. In the accompanying drawings, like reference numbers in different drawings may designate similar elements.

In the following description, numerous specific details are provided to convey a thorough understanding of the present invention. Other combinations of features can be utilized and would remain in the scope of the invention. No single feature or features described should be considered essential to the invention besides spacing of photovoltaic arrays at 7 meters to 11 meters.

Unless otherwise indicated, all numbered herein used to express quantities, dimensions, and so forth, should be understood as being modified in all instances by the term “about.”

As used herein, the term “photovoltaic panel array,” “photovoltaic panel array row,” “panel array,” “solar array,” or “array” refers to a grouping of a plurality solar panels in a row and their operational equipment such as their racking systems which are mounted into the ground.

As used herein, the term “agrivoltaics” refers to a dual process or mechanism of using photovoltaic panel arrays for generating electrical power and optimizing growth of agricultural crop or other agricultural activity on the same property or land.

As used herein, the term “solar system,” or “photovoltaic system” refers to a grouping of photovoltaic cells arranged in a generally planar panel enclosure for the photovoltaic generation of electricity.

As used herein, the term “project,” or “system” refers to the complete design of a series of photovoltaic arrays arranged in a particular manner to suit the site chosen, to produce the appropriate amount of solar electricity.

As used herein, the term “post,” “posts,” or “support posts” refers to the steel or other material in the form of a vertical racking pole that attaches the solar panel in a particular angle on one end, and the other is mounted into the ground.

As used herein, the term “racking system” refers to the steel post and frame that the solar panel is secured to.

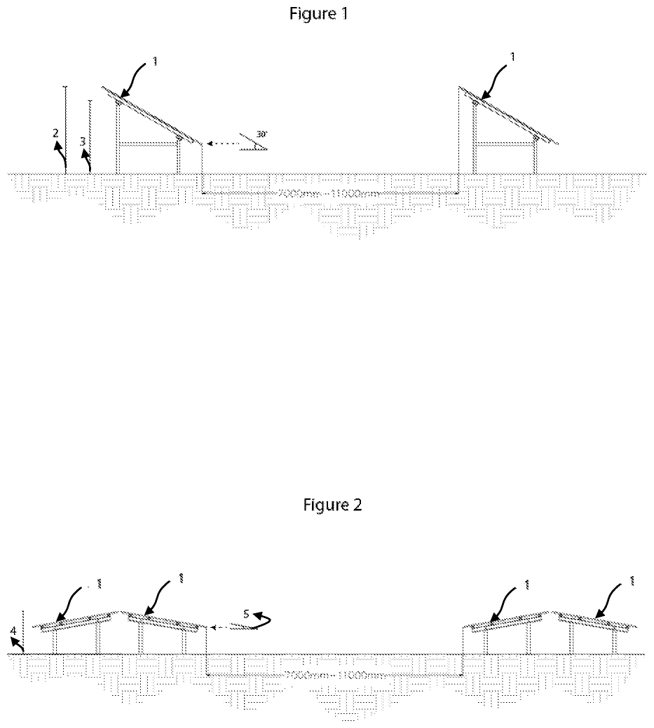

The present invention will now be described with reference to the accompanying drawings, particularly with respect to FIGS. 1-17.

FIG. 1 is a diagram that illustrates a side view of a photovoltaic panel array 1 in a south facing position in its fixed position, in accordance with an exemplary embodiment of the disclosure. In an embodiment, the photovoltaic panel array 1 may be in its fixed or static position at 30 degrees, which may be modified dependent on latitudinal position of the site or farmland. A height of the entire solar panel 2 is 3.069 meters and a height of a racking pole 3 may be standard or increased to allow for more space under the arrays.

FIG. 2 is diagram that illustrates a side view of the photovoltaic panel array 1 in a fixed east-west facing orientation, in accordance with an exemplary embodiment of the disclosure. A maximum fixed vertical height 4 of the solar panel is 3.069 meters. An angle of tilt 5 of the solar panel array is fixed at an angle between 5-15 degrees.

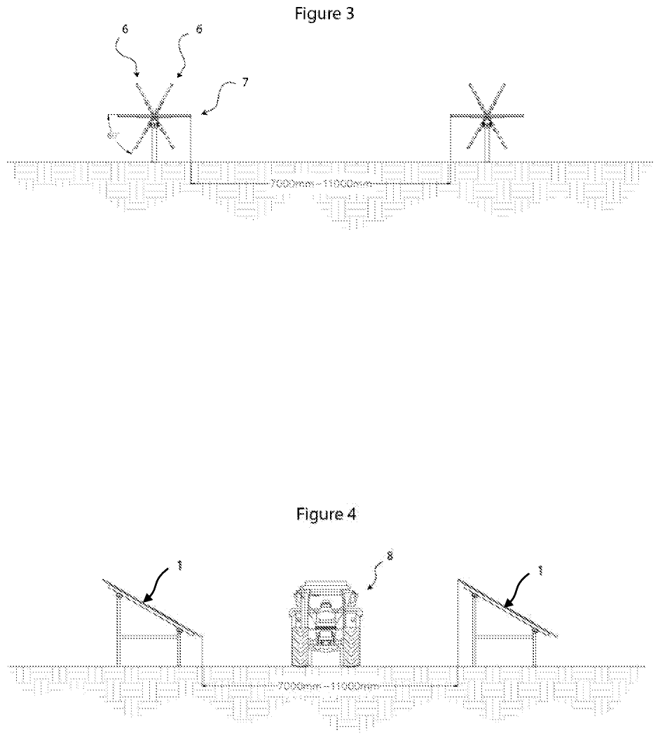

FIG. 3 is a diagram that illustrates a side view of a single axis tracker photovoltaic panel array 1 in its typical raised position along with panel rotation or movement in 60-degree intervals according to sun position, in accordance with an exemplary embodiment of the disclosure. A maximum height of the panel and racking system 6 is 2.724 meters. Here, the panel is in its solar noon lowered position as shown by 7.

FIG. 4 is a diagram that illustrates a side view of fixed tilt south facing photovoltaic panel arrays 1 spaced apart, in accordance with an exemplary embodiment of the disclosure. The photovoltaic panel arrays are spaced apart by 7000 mm-11000 mm (7 m-11 m). A typical large-scale farming machine 8 may operate between the array rows because of the provided spacing between the arrays.

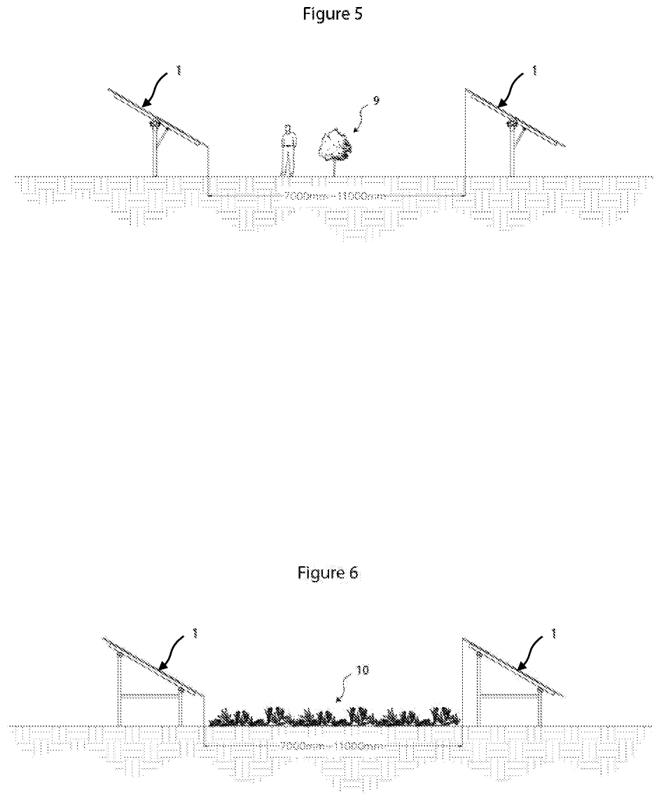

FIG. 5 is a diagram that illustrates a side view of a dwarf apple tree orchard 9 between the photovoltaic panel arrays 1, in accordance with an exemplary embodiment of the disclosure. The dwarf apple tree orchard 9 may grow to any height between 5-6 feet. The panel arrays 1 are in a south facing fixed tilt orientation. The tree 9 is located near the southern panel array to reduce shading and maximize sunshine on the tree 9.

FIG. 6 is a diagram that illustrates a side view of the photovoltaic panel arrays 1 in a south-facing orientation with crops 10 between the arrays 1, in accordance with an exemplary embodiment of the disclosure. As shown, the crops 10 may be planted between the photovoltaic arrays 1. The photovoltaic panel arrays 1 are spaced apart by 7000 mm-11000 mm (7 m-11 m).

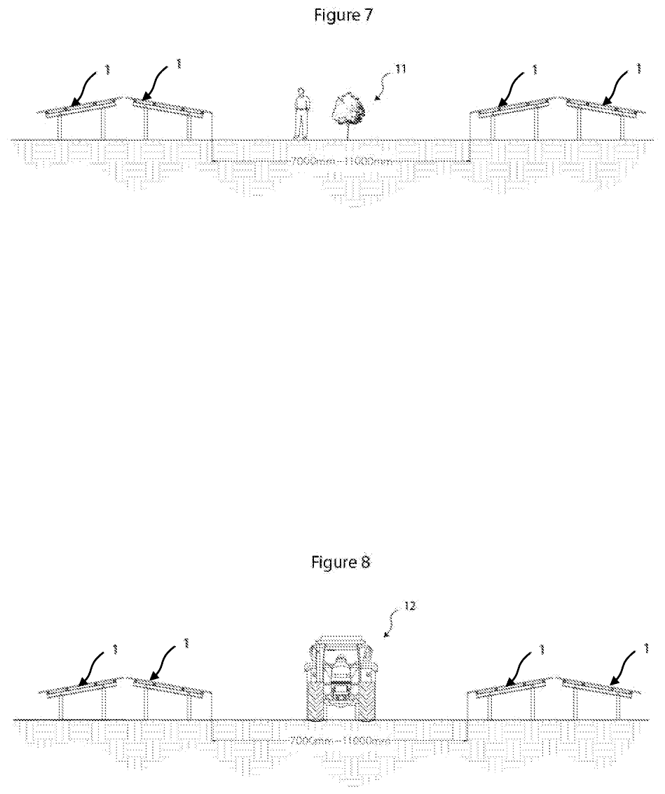

FIG. 7 is a diagram that illustrates a side view of the photovoltaic panel arrays 1 in an east-west orientation with a row of dwarf orchard trees 11 between the photovoltaic arrays 1, in accordance with an exemplary embodiment of the disclosure. The dwarf apple tree orchard 11 may grow to any height between 5-6 feet. The panel arrays 1 are in the east-west orientation. The tree 11 is located near the panel array to reduce shading and maximize sunshine on the tree 11. The photovoltaic panel arrays 1 are spaced apart by 7000 mm-11000 mm (7 m-11 m).

FIG. 8 is a diagram that illustrates a side view of the photovoltaic panel arrays 1 in an east-west orientation that allows a farming equipment 12 to pass between the arrays 1, in accordance with an exemplary embodiment of the disclosure. The photovoltaic panel arrays 1 are spaced apart by 7000 mm-11000 mm (7 m-11 m). A typical large-scale farming machine 12 may operate between the array rows because of the provided spacing between the arrays 1.

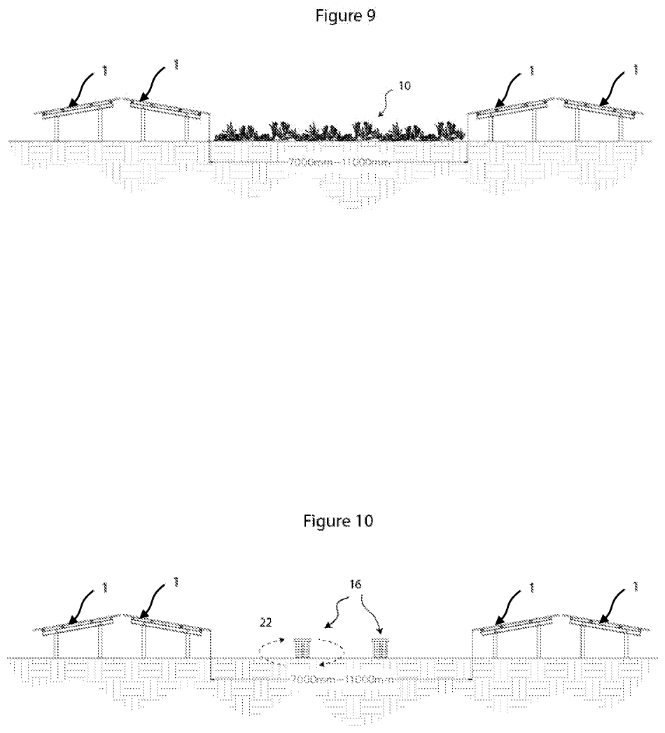

FIG. 9 is a diagram that illustrates a side view of the photovoltaic panel arrays 1 in an east-west orientation that allows for crop rows 10 to grow between the arrays 1, in accordance with an exemplary embodiment of the disclosure. As shown, the crops 10 may be planted between the photovoltaic arrays 1. The photovoltaic panel arrays 1 are spaced apart by 7000 mm-11000 mm (7 m-11 m).

FIG. 10 is a diagram that illustrates a side view of the photovoltaic panel arrays 1 in an east-west orientation that allows for standard beekeeping hives 16 between the arrays 1, in accordance with an exemplary embodiment of the disclosure. Each hive may require a 7 feet radius as shown by 22 in FIG. 10. The hives are placed between the photovoltaic arrays 1 and are spaced apart by 7000 mm-11000 mm (7 m-11 m).

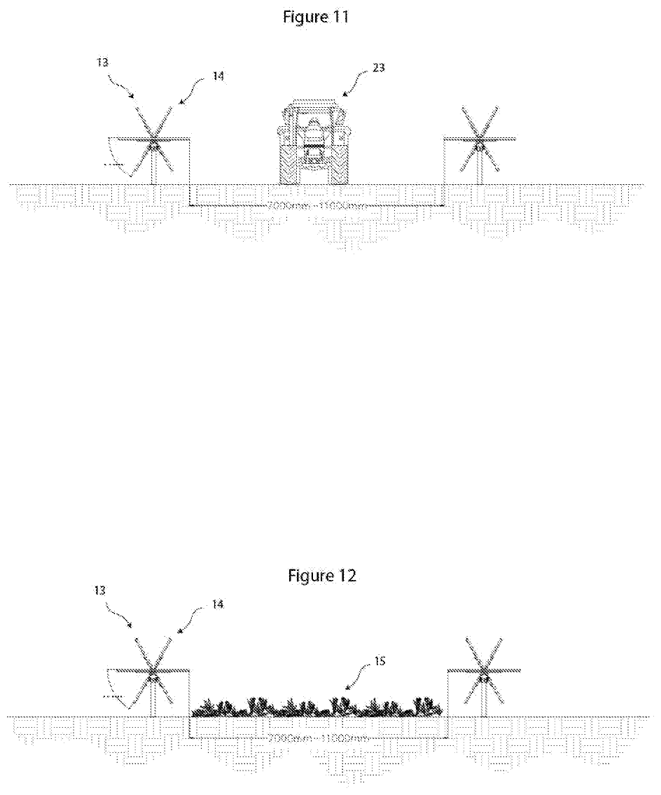

FIG. 11 is a diagram that illustrates a side view of single axis tracker photovoltaic panel arrays in its typical raised position along with panel rotation according to sun position, in accordance with an exemplary embodiment of the disclosure. The photovoltaic panel arrays 13 and 14 in its typical raised position have been shown along with the panel rotation according to the sun position. There is ample space between arrays to accommodate standard sized farming equipment 23.

FIG. 12 is a diagram that illustrates a side view of single axis tracker photovoltaic panel arrays 13 and 14 in its typical raised position along with panel rotation according to the sun position, in accordance with an exemplary embodiment of the disclosure. The crop rows 15 are located between the arrays.

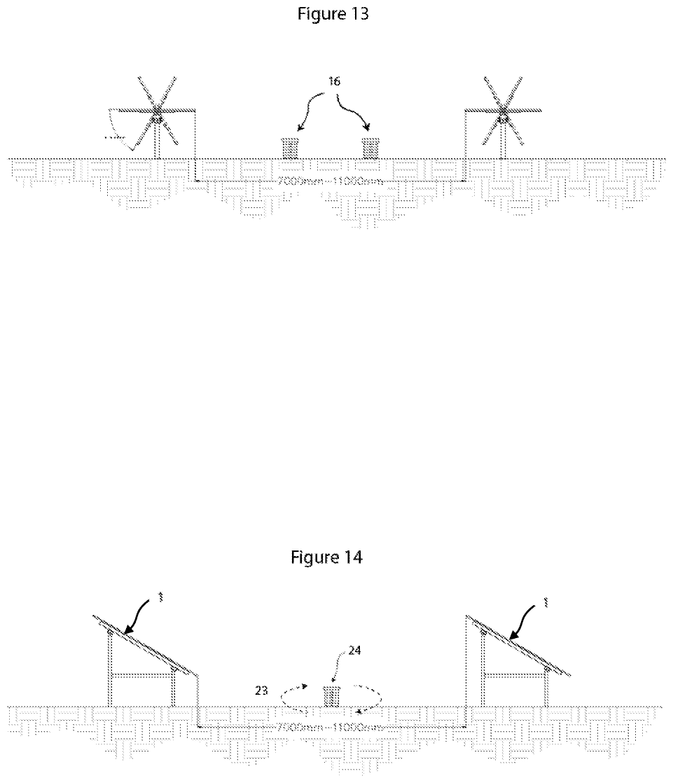

FIG. 13 is a diagram that illustrates a side view of single axis tracker photovoltaic panel arrays in its typical raised position along with panel rotation according to sun position, in accordance with an exemplary embodiment of the disclosure. Beekeeping activities 16 may operate between the panel arrays as shown.

FIG. 14 is a diagram that illustrates a side view of the photovoltaic panel arrays 1 in a south-facing orientation that allows for standard beekeeping hives 24 between the arrays 1, in accordance with an exemplary embodiment of the disclosure. The photovoltaic arrays may allow the standard beekeeping hives 24 between the arrays. Each hive may require a 7 feet radius 23. The number of hives between the arrays may be dependent on a type of hive and a size of hive.

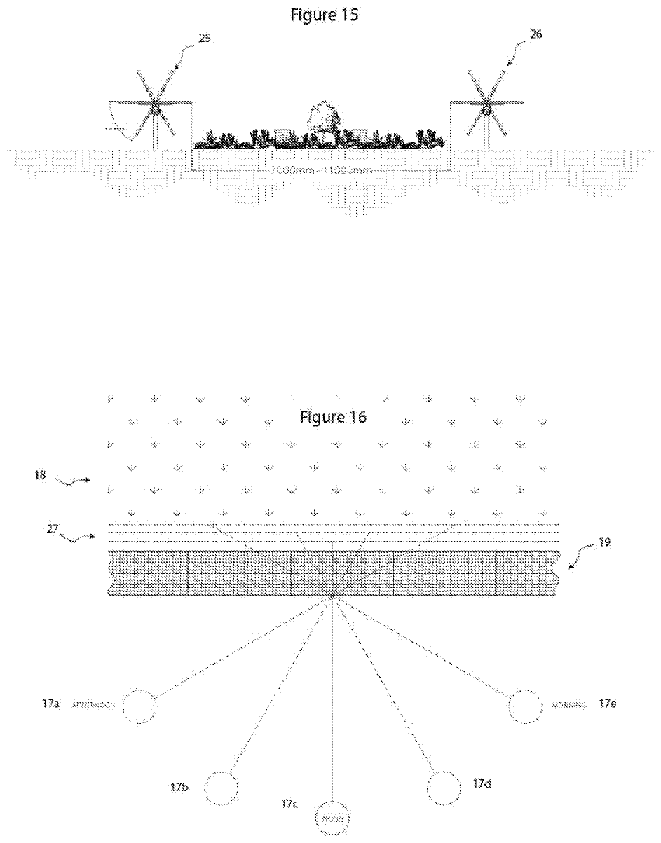

FIG. 15 is a diagram that illustrates a side view of two rows of single axis tracking photovoltaic panel arrays 25 and 26 with a combination of crops, dwarf trees, and beehives, in accordance with an exemplary embodiment of the disclosure.

FIG. 16 is a diagram that illustrates a top down view of the sun's position during different times of the day 17a, 17b, 17c, 17d, and 17e relative to the photovoltaic panel array, in accordance with an exemplary embodiment of the disclosure. This may result in various levels of shade 27 that do not impact the ability of the crops 18 to have access to sunlight.

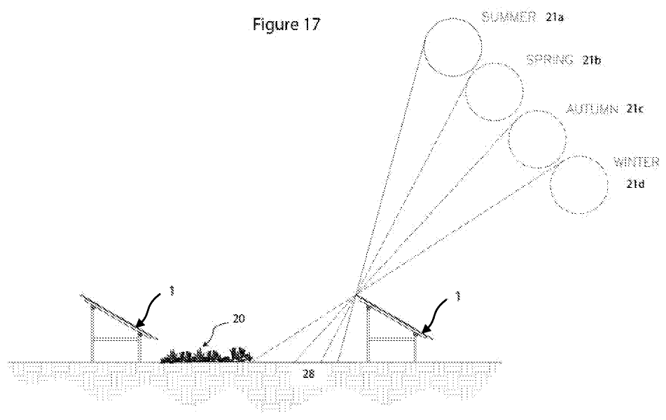

FIG. 17 is a diagram that illustrates a side view of two rows of south-facing fixed tilt panel arrays 1 with a row of crops 20 between the arrays, in accordance with an exemplary embodiment of the disclosure. The sun's position in various seasons 21a, 21b, 21c, and 21d does not affect the access of the crops to sunlight. The shading 28 caused by the seasonal sun positions will vary depending on geographical location. The distance between the arrays can accommodate a shading range caused by the panels.

The present invention is a design for a large-scale photovoltaic panel array. The arrays are mounted directly on agricultural lands with spacing of 7-11 meters between each array row to allow for continued agricultural activities. The spacing allows for sizable machinery to operate between the rows, thereby enhancing native and new farming operations on the same land while generating solar power using the solar panels. The power generation may be optimized by having each solar panel oriented so that the wide surfaces of each panel are perpendicular to the sunlight flow. The photovoltaic panel array rows are installed at a distance of 7 meters to 11 meters apart, and thus allowing for solar power to be produced on the farmland while sustaining and often improving the quality of the land and crops. The arrays are spaced to ensure that the necessary sunlight may reach the crops during the daylight hours. The amount of direct sunlight on the crops may be dependent on a geographic location, a time of a day, and a time of a year, along with the installation and movement of the solar panels on the farmland. However, the spacing allows for modification of array row spacing to increase up to 11 meters and decrease down to 7 meters depending on the geographic location of the site. The arrays may also provide appropriate shading for certain crops that require it, leading to less “sunburn” of crops and reduction in the crop waste. The spacing modification may adjust the amount of shading and when shading will occur to produce optimal growing conditions. This modification is within the scope of the invention. The panels mounted on the ground at this spacing will also provide proper shelter for crops from wind or environmental damage.

In an embodiment, the height of the panel racking system, which is between 1.5 meters to 3 meters on an average, does not affect the photovoltaic system's efficiency or crop growth. Spacing may be adjusted to be 7 meters and it may go up to 11 meters apart to account for shade caused by racking and panel height while maintaining sufficient space between the photovoltaic arrays for continued farming and agricultural activities. The spacing has been deliberately chosen to enhance the use of the agricultural land in addition to producing large amounts of solar power through the photovoltaic arrays and maintaining the efficiency of the panels by minimizing the shading caused by the panels on each other. The aim is to achieve a balance of optimized crop growth and electrical power generation.

The disclosed system does not require the additional cost of processors or the combination of devices to track the sunlight in order to allow for sunlight penetration to the crops. This increases the adoption rate of large solar array systems. This system, however, is compatible (i.e., installed or integrated) with a tracking device including a tracking software for controlling the movement of the solar panels in accordance with the sun position. The tracking device may be configured to detect the sun's light during the daylight time, and accordingly may be configured to execute the tracking software. Based on the execution of the tracking software, the tracking device may be configured to control the movement of the solar panels in accordance with the sun position. When the sun has set and there is no sun's light, for example, during evening time or nighttime, in that case, the tracking device stops the movement of the solar panels and then causes the solar panels to return to its initial or starting position. The panel movement is performed in 60 degrees intervals in accordance with the sun position. The movement of the solar panels does not affect the crop growth or sunlight exposure to the crops. The use of tracking software and rotating panels (as shown in FIG. 3) provides the added benefit of additional space both vertically as well as horizontally so that any additional farming practices may take place and varying equipment may be used. Growing crops between the solar arrays at the distance of under 11 meters has the additional advantage of reduced water and irrigation costs due to the staggered periods of shading. Shading reduces evapotranspiration of water before it can be utilized by the crops.

In an embodiment, a preferred solar panel is 2.180 meters (i.e., 7.152 feet) in length by 0.995 meters (i.e., 3.264 feet) in width on a racking system between 1.5 meters (i.e., 4.921 feet) to 3 meters (i.e., 9.842 feet) high. The height of the supporting pole above ground and the racking system may be adjusted and will not affect the utility of the invention and remains within the scope of the invention. Alternate foundation configurations and structural installation adjustments and modifications are within the scope of the invention. The racking system may also be made higher off the ground to allow for more clearing underneath the arrays. The space below the panels may accommodate the growth of tree crop, sheep grazing, and other agricultural activities. To accommodate the higher racking system, the pole may have to be installed deeper into the ground, which is more costly but will allow for higher crop to grow and a larger quantity of crop to grow.

Referring to FIGS. 1, 2, and 3, the photovoltaic panel array rows are 7 meters to 11 meters apart. FIG. 4 shows that the spacing will allow large agricultural equipment to pass between. If the farmland is in existence prior to the installation of the photovoltaic system, the farming equipment (that is already used) may be accommodated by the new spacing, thereby reducing the costs of replacing farming equipment for the farmer. By allowing for dual use of the land with agriculture and energy generation, there will be a decreased use of toxic chemical fertilizers and pesticides. With portions of the land used to house the photovoltaic system, there would be no farming on those sections. This allows for soil conditions to remain chemical free, which will allow for soil health to improve and groundwater to remain uncontaminated. By the same token, including agricultural activities on the same land as the photovoltaic system contributes to biodiversity, therefore also improving soil health. This invention includes innovative ways to maximize the usage of the land by which the system sits by not only focusing on monoculture farming but ways to increase biodiversity and also harvesting crops that traditionally would be incompatible with agrivoltaics systems that rely on a support structure over the land.

This agrivoltaics system is ideal for apple orchard sites that grow dwarf apple trees, which are commonly overlooked due to tree cover causing shading of the solar panels and the vertical growth interfering with the photovoltaic arrays supported on platform structures above crops.

Referring to FIGS. 5, and 7, the standard dwarf apple tree stands at 5 feet (i.e., 1.524 meters) to 6 feet (i.e., 1.829 meters) tall. The spacing of 7 meters allows for both tree growth and harvesting of fruit. The trees will not shade the panels if the arrays are stationed a minimum of 7 meters apart depending on the geographical location. The location, the time of the day, and the time of the year may change the position of the arrays and independent studies of sunlight patterns of a specific site may determine the spacing of the arrays up to a maximum of 11 meters to ensure power generation amounts are reached. This does not limit the invention to dwarf apple trees but encompasses all tree agriculture with growth heights of up to 6 feet.

This agrivoltaics system extends beyond the traditional crop farming usage. This system is suitable for livestock farming, specifically sheep. The sheep have enough space to graze between the arrays with necessary protection of poles and electrical equipment through barriers installed around poles. Sheep grazing may decrease operation and maintenance costs by up to 30% according to the American Solar Grazing Association (ASGA) and they may maintain the cover crop to ensure soil arability due to organic fertilizer from the sheep and aeration of the soil through sheep movement. Maintaining the cover crop of grass and possible wildflowers ensures the soil is rejuvenated and may continue to adapt and be used for future agricultural endeavors. The cover crop may be modified to any variety of crop and does not affect the scope of the invention.

The agrivoltaics system is designed with specific spacing in mind to accommodate both pollinator cultivation as well as wildflower growth. Steady decline in pollinator populations has raised concerns about food security. This invention allows for beekeeping initiatives to continue between the array rows with commercial hives, typically using Langstroth hives which are located in boxes traditionally 16 inches wide (i.e., 0.406 meters) by 19⅞ inches long (i.e., 0.505 meters) and can be stacked. Traditionally, there will be one to two boxes stacked. The radius around a hive should be maintained at 7 feet (i.e., 2.134 meters). The invention with array distance between 7 meters to 11 meters may accommodate beekeeping and may not intrude on the activities of the bees and apiarists.

In an embodiment, the panels may be tilted between 5 degrees to 40 degrees depending on the latitude of the site. FIG. 1 depicts a common 30-degree tilt. The panels are orientated facing south if above the equator and north facing if site is located south of the equator. However, modifications to the tilt and direction depending on site specific design requirements remain within the scope of the invention so long as the spacing between the array rows is between 7 meters to 11 meters from the mounting pole 4. The array row is made up of a minimum of two solar panels and may be configured with additional panels to adapt to the size of the site and the power generation system size.

The present invention allows sunlight to reach the agricultural land between the photovoltaic array rows by a static method. The invention allows for the integration of technology and nature, and utilizes the limited resource of available, arable land to its fullest potential. Many other embodiments are possible depending upon but not limited to the following parameters: land latitude, type of crop, weather, growing season, time of year, irrigation systems, fertilization methods, crop growth stage and scheduled agricultural work such as ploughing, planting, fertilizing, pest control, weed control and harvesting.

This present invention of a large-scale solar array system designed with 7 meters to 11 meters between rows is an advancement to the adoption of renewable energy on agricultural land. This method allows for high adoption by farmers and the community due to a multitude of factors. By allowing the existing agricultural activities to coexist with the newly installed photovoltaic system, there is a financial gain for farmers and community members. There is a cultural or historical preservation of farming methods that are important to the way of life for many local residents. The solar system remaining mounted on the ground as opposed to being mounted on an overhead support structure allows for reduced costs to develop the photovoltaic system, is aesthetically more pleasing to local residents due to the screening that can be installed, therefore limiting the sightline to the system. Experience has precluded that minimizing the visual impact of the photovoltaic system is key to adoption of renewable energy projects, and solar energy projects in particular.

This method of incorporating additional embodiments such as sheep, beekeeping, and operation of orchards in conjunction with a photovoltaic system emphasizes the vast combinations and modifications that can suit various geographic locations and cultures. The method creates an ecosystem whereby agriculture and crop production can improve with the availability of pollinators, cover crops can help sustain livestock with grazing room and food while maintaining soil health, and commonly overlooked forms of agriculture such as orchards can coexist with an operational photovoltaic system.

Techniques consistent with the disclosure provide, among other features, the photovoltaic panel arrays that are spaced from a first distance (for example, 7 meters i.e., 22.9659 feet) to a second distance (for example, 11 meters i.e., 36.0892 feet) apart. Such arrangement of the photovoltaic panel arrays may allow for a wider variety of agricultural use ranging from beekeeping, sheep grazing, monocropping, intercropping, polyculture, and the like, as it allows for adequate spacing for the average farming machine to pass between array rows. While various exemplary embodiments of the disclosed invention have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A system for producing solar power while allowing agricultural practices to continue or begin between array rows, the system comprising:
an array of solar panels installed on a farmland with a gap or spacing distance of 7 meters to 11 meters apart from a subsequent array,
wherein planting crops, grazing livestock, beekeeping, in addition to any agricultural practices suitable for the land exist regardless of the solar panels,
wherein a crop suitability is selected based on a location of a site,
wherein the arrays are located while continuing to increase biodiversity of the agricultural land, and
wherein such installation has a positive yield of solar power in addition to income from crop yield; and
a tracking device including a tracking software installed in the solar panels for controlling movement of the array of the solar panels.

2. The system of claim 1, wherein the array of solar panels is in a static position at 30 degrees.

3. The system of claim 1, wherein the array of solar panels is tiltable along their axis, and wherein an angle of tilt of the solar panels is fixed at an angle between 5-15 degrees.

4. The system of claim 1, wherein the spacing of 7 meters to 11 meters between the solar panels allows one or more mechanized farm equipment to pass between array rows, and thereby providing proper spacing for planting and harvesting of crops.

5. The system of claim 1, wherein panel orientation of the solar panels includes at least fixed tilt system or single axis tracking system.

6. The system of claim 5, wherein the tracking device is installed in the solar panels for controlling the movement or orientation of the solar panels in accordance with sun position.

7. The system of claim 6, wherein the movement of the solar panels is controlled in a way that it does not impede crop growth or other farming activities between rows due to adequate spacing of 7 meters minimum and maximum of 11 meters.

8. The system of claim 6, wherein tracking of the solar panels to the position of the sun helps in optimizing power or energy generation in addition to providing adequate sunshine and shade to enhance growing conditions.

9. The system of claim 6, wherein the panel movement is performed in 60 degrees intervals in accordance with the sun position.

10. The system of claim 1, wherein the solar panels are spaced to ensure that necessary sunlight reaches the crops during daylight hours.

11. The system of claim 1, wherein an amount of direct sunlight on the crops is dependent on a geographic location, a time of a day, and a time of a year, along with the installation and movement of the solar panels on the farmland.

12. The system of claim 1, wherein the solar panels are installed on a panel racking and a height of the panel racking is between 1.5 meters to 3 meters.
